(19) United States
(12) Patent Application Publication
(10) Pub. No.: US 2026/0007126 A1
(43) Pub. Date: Jan. 8, 2026

(54) MOSQUITO AND BUG REPELLENT DISPENSER

(71) Applicant: Richard Castle, Windham, NH (US)

(72) Inventor: Richard Castle, Windham, NH (US)

(21) Appl. No.: 19/083,823

(22) Filed: Mar. 19, 2025

Related U.S. Application Data
(60) Provisional application No. 63/668,202, filed on Jul. 6, 2024.

(51) Int. Cl. A01M 1/24

(52) U.S. Cl. CPC A01M 1/245

(57) ABSTRACT

The present disclosure relates to a repellent dispenser for bugs and mosquitoes. The dispenser contains a body housing one or more repellent reservoirs, and a blower or compressor connected to the one or more repellent reservoirs. The blower or compressor is further connected to one or more dispensing horns or tubes. A dispensing horn or an end cap exhaust may also be connected to the end of a tube. The repellent reservoirs may include sensors that are able to detect a liquid level in each of the one or more repellent reservoirs and send a signal when the liquid level is below a threshold. The blower or compressor can be set to operate for a preset duration, at specific intervals, at a designated time, or at a designated power level. The dispenser may also have a tab that enables the dispenser to be mounted on a parapet or handrail.

### TECHNICAL FIELD

The present disclosure relates to the field of pest control technology.

### BACKGROUND

Pest control is essential for the enjoyment of both private and public spaces, such as yards, outdoor pools, parks, and dining areas. However, state-of-the-art technologies for mosquito and insect deterrents have a few drawbacks. First, they typically cover a small, localized area. Second, they are often inefficient, with a significant portion of pest-repelling chemicals dissipating due to heat. Additionally, an automated pest control system that dispenses repellents at set intervals could save considerable labor.

Hence, it could be helpful to develop a pest control system that could address the aforementioned problems.

### SUMMARY

The presently disclosed mosquito and insect repellant dispenser is designed as a perimeter guard, spreading mosquito and/or bugs repelling natural scents such as, but not limited to, citronella, lavender, mint, and eucalyptus. The dispenser comprises an enclosed blower box with essential oil reservoirs that use the venturi effect to carry the scent through a perimeter tube.

The presently disclosed technology may include a few embodiments with the same underlying principles. The first was designed as a battery-powered, solar-recharging deck/porch perimeter system to repel mosquitoes and other insects within the defined perimeter. This is a constant feed of scent while in use. The blower inside of the enclosure pushes the scent through a vented tube over a defined perimeter. The theory being that this dispersed repellent over the entire space will vastly improve the effectiveness.

Another embodiment may be a 120 VAC land-powered larger blower box for use in yards, pool areas, outdoors dining at restaurants, etc. This type would be on a timer (for restaurant applications) on Bluetooth connectivity to turn it on prior to using the area. It will use similar tubing of increased diameter based on the coverage area.

Yet another embodiment may include detaching the porch perimeter guard blower box and using it remotely in other areas not already protected by the perimeter system.

In some embodiments, the presently disclosed technology may include the following components: a blower/fan, a lithium-ion battery, a solar panel, a solar controller, a manual switch, an ABS enclosure with a diffuser, flexible tubing with vent holes, and deck rail mounting clips.

In some embodiments, the presently disclosed pest control system may also apply to rodents such as mice, rats, squirrels, and hedgehogs, etc.

### BRIEF DESCRIPTION OF THE DRAWINGS

The present disclosure is further illustrated by way of exemplary embodiments, which are described in detail through the accompanying drawings. These embodiments are not limiting, and in these embodiments, the same numbering indicates the same structure, wherein:

FIGS. 1A and 1B are isometric view structural diagrams of a closed mosquito and bug repellent dispenser, according to a small-scale exemplary embodiment of the present disclosure;

FIG. 2 is an isometric view structural diagram of the mosquito and bug repellent dispenser when opened, according to the small-scale exemplary embodiment of the present disclosure;

FIG. 3 is a diagram showing the installation of the presently disclosed technology, according to the small-scale exemplary embodiment;

FIG. 4 is an isometric view structural diagram showing an alternative design of the mosquito and bug repellent dispenser, according to a large-scale exemplary embodiment of the present disclosure;

FIG. 5 is another isometric view structural diagram showing the alternative design of the mosquito and bug repellent dispenser, according to the large-scale exemplary embodiment of the present disclosure, along with a control panel;

FIG. 6 is a block diagram illustrating the functioning of the presently disclosed technology, according to some embodiments, including both the small-scale and the large-scale exemplary embodiments.

### DETAILED DESCRIPTION

In order to more clearly illustrate the technical solutions of the embodiments of the present disclosure, the accompanying drawings for the description of the embodiments are described below. Obviously, the accompanying drawings in the following description are only some examples or embodiments of the present disclosure, and it is possible for a person of ordinary skill in the art to apply the present disclosure to other similar scenarios in accordance with these accompanying drawings without creative labor. Unless obviously obtained from the context or the context illustrates otherwise, the same numeral in the drawings refers to the same structure or operation.

It should be understood that the terms “system,” “device,” “unit,” and/or “module” are used herein as a way to distinguish between different components, elements, parts, sections, or assemblies at different levels. However, if other words may achieve the same purpose, the terms may be replaced with alternative expressions.

As indicated in the present disclosure and in the claims, unless the context clearly suggests an exception, the words “one,” “a,” “a kind of,” and/or “the” do not refer specifically to the singular but may also include the plural. In general, the terms “include” and “comprise” suggest only the inclusion of clearly identified steps and elements, which do not constitute an exclusive list, and the method or device may also include other steps or elements.

The present disclosure includes two exemplary embodiments: a small-scale mosquito and bug repellant dispenser and a large-scale mosquito and bug repellant dispenser. The small-scale embodiment may be suitable for private outdoor spaces, such as decks and porches, while the large-scale embodiment may be suited for public outdoor areas, including yards, poolside spaces, and outdoor dining areas at restaurants. Additionally, the present disclosure encompasses other embodiments that may be considered obvious variations of the two exemplary embodiments by a person of ordinary skill in the art.

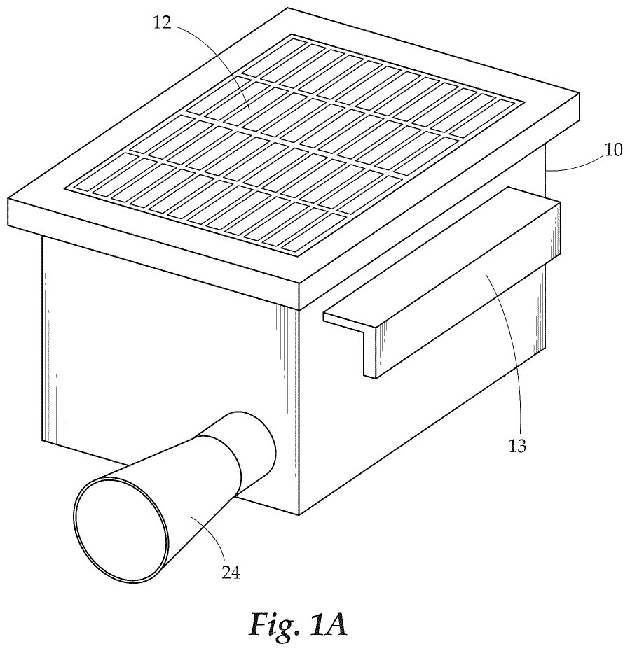

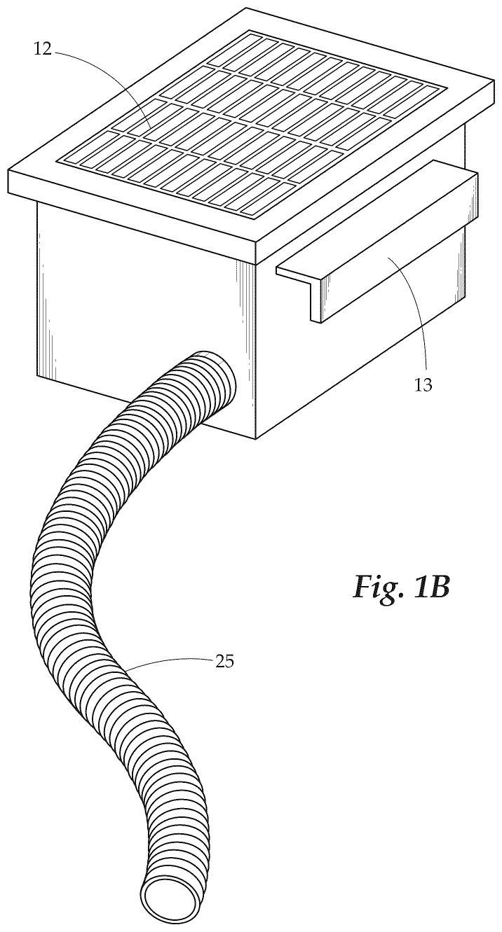

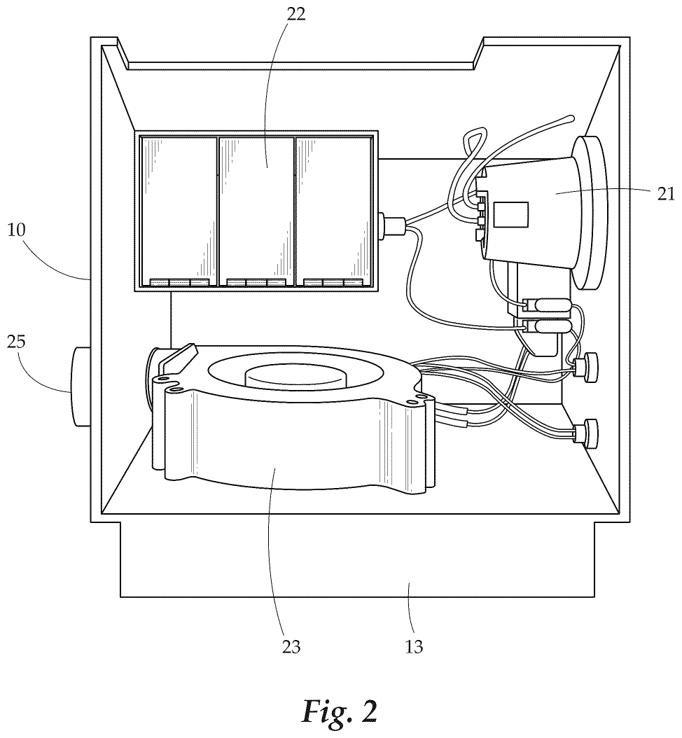

FIGS. 1A and 1B are isometric view structural diagrams of a closed mosquito and bug repellent dispenser, according to the small-scale exemplary embodiment of the present disclosure; FIG. 2 is an isometric-view structural diagram of the mosquito and bug repellent dispenser when opened, according to the small-scale exemplary embodiment of the present disclosure.

The small-scale exemplary embodiment may include a box-shaped body 10 with a top opening that provides access to internal components, as shown in FIG. 2. The opening may feature a hinged lid, removable lid, flap, lift-off top, slide-top, or other types of covers. In some embodiments, the hinged lid may incorporate solar panels 12, allowing the device to be charged using solar batteries. Alternatively, the device may be powered by other types of batteries and/or connected to a power outlet. For instance, the embodiment shown in FIG. 2 includes a power outlet connector 21, through which the device can connect to an external power source.

In certain applications, power outlets may be preferred over batteries due to the higher power demands of some functionalities. Conversely, batteries may be advantageous for improved maneuverability. Solar batteries also offer an environmentally friendly option. Some embodiments may include both one or more batteries and one or more power outlet connectors 21 to provide greater flexibility and reliability.

As shown in FIG. 2, the presently disclosed technology may include one or more reservoirs 22 housed in the body 10. In some embodiments, the reservoirs 22 may contain various mosquito and bug repellents, including but not limited to chemical-based options such as DEET (N, N-Diethyl-meta-toluamide), picaridin, permethrin, IR3535, and citronella-based products, as well as plant-based repellents like lemon eucalyptus oil (PMD), lavender oil, tea tree oil, peppermint oil, and neem oil. For certain chemical-based mosquito and bug repellents, human presence may be unsafe during and for a period after dispensing. In such cases, the presently disclosed system may provide a warning by indicating its active status, for example, through an LED indicator.

Some embodiments may feature multiple reservoirs 22, allowing different types of repellents to be stored for use against various types of mosquitoes or bugs. These repellents can be mixed in various ways, including premixed, mixed before dispensing, or simultaneously dispensed by the device. Additionally, some embodiments may include sensors within the reservoirs 22 to detect the liquid levels. These sensors may be float sensors, capacitive sensors, optical sensors, conductive or resistive sensors, pressure sensors, or other types.

When the liquid level falls below a predefined threshold, the sensor may send a signal to a central controller 102. The controller could trigger actions such as alerting the user through the control panel 101 or automatically placing an order for more repellents via the internet 107. The central controller 102 may be a microcontroller embedded in the device or an external computerized device such as a smartphone, computer, or tablet. Further details on the central controller will be provided in the following sections. In some embodiments, the threshold may be set by default or adjusted by the user.

In some embodiments, the presently disclosed technology may include a blower or compressor 23 for dispensing repellents, as shown in FIG. 2. The blower or compressor 23 may be housed within the body 10. In certain embodiments, an air blower or spray blower may be used to create a fine mist by utilizing air pressure to atomize and disperse the repellent. Alternatively, a compressor may be employed to provide higher air pressure than blowers. The compressor generates air pressure to push the repellent through a nozzle, producing a spray or mist. In some embodiments, the compressor may generate an air pressure ranging from 10 to 20 psi.

The one or more reservoirs may be connected to the blower or compressor 23 via tubing or hoses for the delivery of repellents. The central controller 102 may regulate the operation of the blower or compressor 23, including turning it on or off and adjusting its power. Details regarding the communication between the central controller 102 and the blower or compressor 23 will be provided in the following sections.

The blower or compressor 23 may connect to a dispensing horn 24 or a tube 25, as illustrated in FIGS. 1A and 1B. In some embodiments, the dispensing horn 24 may be replaced by a spray nozzle. Both the dispensing horn 24 and the spray nozzle may be connected to the end of the tube 25. The dispensing horn 24 is designed to evenly distribute the repellent, converting it into a spray or mist for effective coverage. It can also direct the flow to target specific areas, regulate the pressure or flow rate, and aid in atomization to enhance efficiency. A spray nozzle performs similar functions.

In some embodiments, multiple dispensing horns 24 may be positioned on the body 10 of the apparatus to increase the coverage area. For example, two identical dispensing horns 24 may be placed at opposite ends of the body 10 to achieve 360-degree or near-360-degree coverage. The tube 25 can channel the repellent to remote locations that dispensing horns or spray nozzles cannot reach, which is particularly useful if the device is powered by a plug-in rather than batteries.

In some embodiments, the tube 25 may feature multiple branches or perforations along its length to further expand the coverage area, provided the blower or compressor 23 can support this added functionality. If the blower or compressor 23 delivers sufficient power, the radius of the tube 25 may be reduced to enhance maneuverability and simplify the installation of the disclosed apparatus.

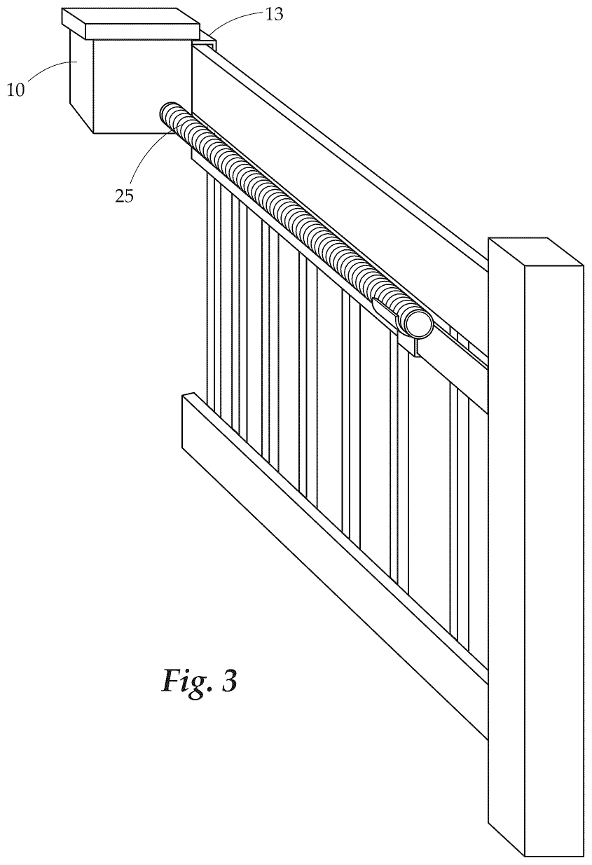

FIG. 3 is a diagram illustrating the installation of the presently disclosed technology in a small-scale exemplary embodiment, as well as other potential embodiments.

In certain embodiments, the disclosed device may include a tab 13 on one side of the body 10 to facilitate mounting onto a balcony, a deck, a porch railing, a fence, or the like. For instance, as depicted in FIG. 3, the tab 13 may rest atop a balcony parapet, which could alternatively be a handrail of a railing or the like, allowing the body 10 to be suspended. The device can be further secured to the parapet or railing using various fastening mechanisms, such as hooks, brackets, straps, clamps, screws, bolts, or similar options.

In some embodiments, as shown in FIG. 3, the tube 25 may be secured along a parapet, handrail, or similar structure using a plurality of hooks, clips, or straps. The entire length or a substantial portion of the tube 25 may be secured along the parapet (or handrail, etc.). Additionally, the tube 25 may include a series of dispensing holes spaced at intervals along its length, allowing for broader and more even distribution of the repellent. To further enhance coverage, dispensing horns may be attached to these holes. If the tube 25 is secured along a fence, dispensing holes may be positioned on both sides to maximize effectiveness. In these embodiments, the compressor or blower 23 may provide sufficient power to ensure proper dispensing of the repellent through multiple holes.

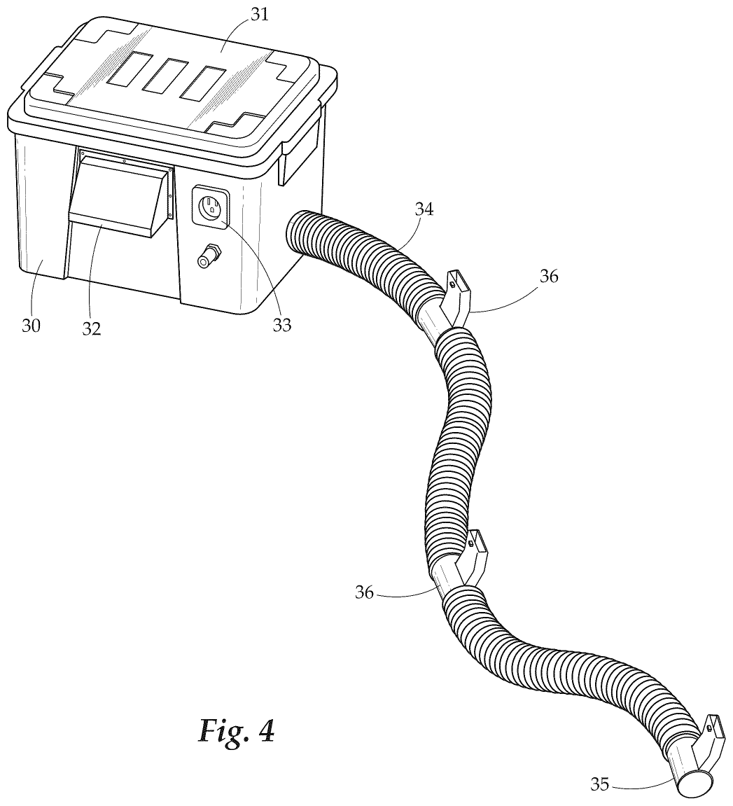

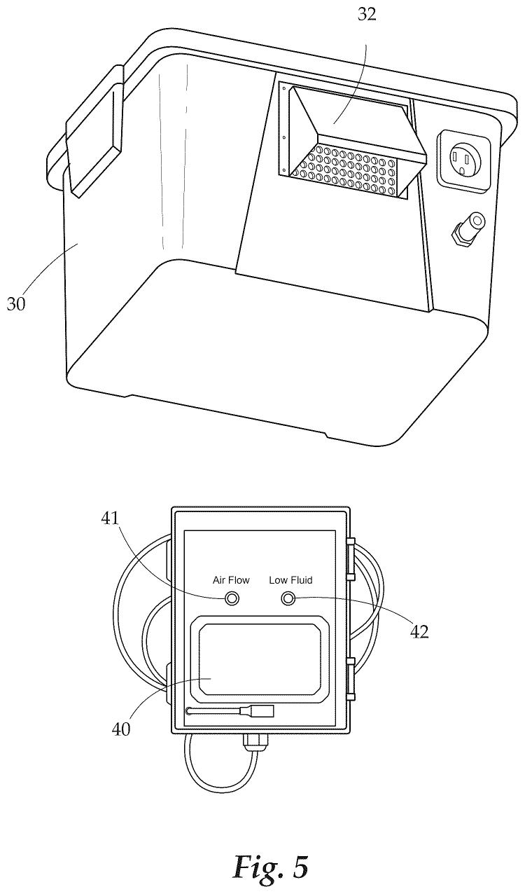

FIG. 4 is an isometric-view structural diagram showing an alternative design of the mosquito and bug repellent dispenser, according to a large-scale exemplary embodiment of the present disclosure; FIG. 5 is another isometric view structural diagram showing the alternative design of the mosquito and bug repellent dispenser, according to the large-scale exemplary embodiment of the present disclosure, along with a control panel. As discussed above, the large-scale exemplary embodiment has a larger size and may cover a larger area, which may be suitable for public outdoor spaces such as yards, pool areas, and outdoor dining areas at restaurants.

The large-scale embodiment is typically designed to be directly placed on the ground or other level surfaces rather than mounted on a parapet or handrail. Since it most likely requires a higher power input compared to the small-scale embodiment, it is preferably connected to a power source via a power outlet connector 33 instead of using a battery. To enhance maneuverability, the large-scale embodiment may, in some embodiments, include wheels.

The large-scale embodiment may include a body 30 that houses components such as, but not limited to, the reservoir and either a blower or a compressor. Given its potentially higher power requirements, the large-scale embodiment may preferably be equipped with a compressor instead of a blower. Additionally, the large-scale embodiment may include a lid 31 on top of the body 30, allowing access to its internal components.

In some embodiments, the body 30 may incorporate an intake hood 32 designed to draw air from the environment into the body 30. The intake hood 32 may feature multiple inlets and a slanted surface positioned above them. This slanted surface serves to direct the airflow toward the inlets at an optimal angle, minimizing turbulence and ensuring smoother, more efficient airflow. Additionally, the slanted surface helps prevent the entry of larger debris, dust, or water, thereby reducing the risk of inlet blockage and enhancing the overall efficiency of the system.

A tube 34 may be connected to the compressor, with an end cap exhaust 35 attached to the end of the tube to direct airflow and dispense the scented air output from the compressor. In some embodiments, the end cap exhaust 35 may be replaced with a dispensing horn or spray nozzle. Additionally, if the compressor's power permits, the device may include multiple tubes or a single tube with multiple branches to expand the coverage area of the repellent.

The large-scale embodiment may include multiple outlets 36 along the tube 34, spaced approximately every 5-10 feet, with an end cap exhaust 35 at the terminus. This arrangement helps ensure a more even distribution of the scent throughout the space.

The large-scale embodiment may also include a control panel 40, which facilitates communication between the user and the device. The control panel 40 may feature various components, including but not limited to LED indicators, buttons, toggles, switches, displays, and touchscreens. In one embodiment, the control panel 40 may include a first LED indicator 41, which shows whether the compressor is on or off, and a second LED indicator 42, which signals if the liquid level in the reservoir falls below a certain threshold. If there are multiple reservoirs, more than one second LED indicators 42 may be used to represent each individual reservoir. In some embodiments, the control panel 40 may be a separate unit from the body 30, connected via wired or wireless communication, allowing the user to control the presently disclosed device remotely. Alternatively, the control panel 40 may be replaced with a computerized device, such as a smartphone, tablet, or computer.

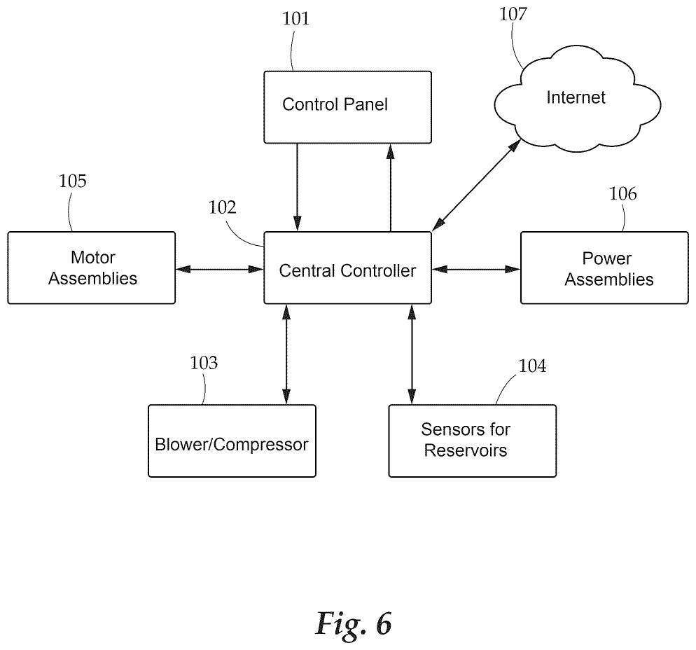

FIG. 6 is a block diagram illustrating the functioning of the presently disclosed technology according to some embodiments.

As discussed above, in some embodiments, the disclosed system may include a control panel 101 through which the user can interact with the device. The control panel 101 may be a physical hardware component integrated into the body of the device or a separate unit, featuring elements such as LED indicators, buttons, toggles, switches, displays, or touchscreens. Alternatively, it may be implemented as a software application on a computerized device.

The control panel 101 may display various information, including but not limited to the device's operational status (on/off), battery level, connection to a power outlet, liquid levels in the reservoir(s), placement of repellent orders, compressor or blower status (on/off), and the power level of the compressor or blower. Additionally, the control panel 101 enables the user to control device functions, such as turning the compressor or blower on or off, adjusting power levels, placing online orders for repellents, or configuring settings. These settings may include scheduling the blower or compressor to operate for a preset duration, at specific intervals, or at a designated time and power level.

The control panel 101 may connect to a central controller 102 through either a wired or wireless connection. The central controller 102 may be a microcontroller embedded within the presently disclosed device or an external computerized device connected to the presently disclosed device via a wired or wireless interface.

The central controller 102 may connect to the blower/compressor module 103 through a wired or wireless connection. It may transmit signals to turn the blower/compressor on or off and adjust its power levels. Additionally, the central controller 102 can configure the blower/compressor settings, including scheduling its operation for a preset duration, at specified intervals, or at a designated time and power level, as previously discussed.

The central controller 102 may connect to one or more sensors located in the reservoir(s) 104 via a wired or wireless connection. These sensors 104 can send signals to the central controller 102 indicating that the liquid level in a reservoir has dropped below a threshold. As discussed above, the central controller 102 may then notify the user with a warning or automatically place an online order for the repellent.

In some embodiments, the central controller 102 may also connect to one or more motor assemblies 105. These assemblies may include one or more motors capable of moving the body 10/30 of the device or specific components, such as the dispensing horn 24, tube 25/34, or end cap exhaust 35, either laterally or rotationally. This functionality enables adjustment of the repellent's coverage area.

In some embodiments, the central controller 102 may connect to the power assemblies 106 via a wired or wireless connection. The power assemblies 106 can transmit signals to the central controller 102, providing information such as whether the power is on or off, whether the device is connected to a power outlet, and the device's battery level.

In some embodiments, the central controller 102 may connect to the internet 107.

Furthermore, unless explicitly stated in the claims, the use of order, numbers, letters, or other names for processing elements and sequences is not intended to limit the order of the processes and methods of the present disclosure. While various examples have been discussed in the disclosure as currently considered useful embodiments of the invention, it should be understood that such details are provided for illustrative purposes only. The appended claims are not limited to the disclosed embodiments, and instead, the claims are intended to cover all modifications and equivalent combinations within the scope and essence of the embodiments disclosed in the present disclosure. For example, although the described system components may be implemented through a hardware device, they may also be realized solely through a software solution, such as installing the described system on an existing processing or mobile device.

Similarly, it should be noted that, for the sake of simplifying the presentation of embodiments disclosed in the present disclosure and aiding in understanding one or more embodiments of the present disclosure, various features have been sometimes combined into a single embodiment, drawing, or description. However, this manner of disclosure does not imply that the features required by the claims are more than the features mentioned in the claims. In fact, the features of the embodiments are less than all the features of the single embodiment disclosed in the foregoing disclosure.

In some embodiments, numeric values describing the composition and quantity of attributes are used in the description. It should be understood that such numeric values used for describing embodiments may be modified with qualifying terms such as “about,” “approximately” or “generally”. Unless otherwise stated, “about,” “approximately” or “generally” indicates that a variation of ±20% is permitted in the described numbers. Accordingly, in some embodiments, the numerical parameters used in the disclosure and claims are approximations, which can change depending on the desired characteristics of the individual embodiment. In some embodiments, the numerical parameters should take into account a specified number of valid digits and employ a general manner of bit retention. Although the numerical ranges and parameters used in some embodiments of the present disclosure to confirm the breadth of the range are approximations, in specific embodiments, such numerical values are set as precisely as practicable.

With respect to each of the patents, patent applications, publications of patent applications, and other material, such as articles, books, specifications, publications, documents and the like, cited in the present disclosure, the entire contents thereof are hereby incorporated herein by reference. Application history documents that are inconsistent with the contents of the present disclosure or that create conflicts are excluded, as are documents (currently or hereafter appended to the present disclosure) that limit the broadest scope of the claims of the present disclosure. It should be noted that in the event of any inconsistency or conflict between the descriptions, definitions, and/or use of terminology in the materials appended to the present disclosure and the contents described herein, the descriptions, definitions, and/or use of terminology in the present disclosure shall prevail.

In closing, it should be understood that the embodiments described in the present disclosure are used only to illustrate the principles of the embodiments of the present disclosure. Other deformations may also fall within the scope of the present disclosure. Therefore, by way of example and not limitation, alternative configurations of the embodiments disclosed in the present disclosure may be considered consistent with the teachings of the present disclosure. Accordingly, the embodiments described in the present disclosure are not limited to the explicitly introduced and described embodiments in the present disclosure.

What is claimed is:

1. A repellent dispenser for mosquitoes and bugs, comprising:
a body, wherein one or more repellent reservoirs and a blower or compressor is placed in an inside of the body;
wherein, the body includes an opening granting access to the inside of the body;
wherein, the opening is covered by a lid;
wherein, the blower or compressor is connected to the one or more repellent reservoirs;
wherein, at least one dispensing horn or tube is connected to the blower or compressor;
wherein the body includes a tab, which rests atop a parapet or handrail, allowing the body to be suspended.

2. The repellent dispenser in claim 1, wherein the one or more repellent reservoirs feature one or more sensors that are able to detect a liquid level in each of the one or more repellent reservoirs.

3. The repellent dispenser in claim 1, wherein the lid includes one or more solar panels.

4. The repellent dispenser in claim 1, wherein the blower or compressor is a blower.

5. The repellent dispenser in claim 1, wherein the blower or compressor is a compressor.

6. The repellent dispenser in claim 1, wherein a dispensing horn is connected to the blower or dispenser.

7. The repellent dispenser in claim 1, wherein a tube is connected to the blower or dispenser.

8. The repellent dispenser in claim 7, wherein a second dispensing horn is connected to an end of the tube.

9. The repellent dispenser in claim 2,
wherein the one or more sensors are connected to a controller;
wherein in response to that the liquid level in any one of the one or more repellent reservoirs drops below a threshold level:
the controller sends a warning or automatically places an online order for additional repellent.

10. The repellent dispenser in claim 1, wherein the blower or compressor can be set to operate for a preset duration, at specific intervals, at a designated time, or at a designated power level.

11. The repellent dispenser in claim 1, wherein a user is able to control an operation of the blower or compressor from a control panel, a touchscreen, or a computerized device that is connected to the blower or compressor.

12. The repellent dispenser in claim 1, wherein the one or more repellent reservoirs include one or more types of repellent selected from a group of chemical-based repellents including DEET (N, N-Diethyl-meta-toluamide), picaridin, permethrin, IR3535, and citronella-based products; and plant-based repellents including lemon eucalyptus oil (PMD), lavender oil, tea tree oil, peppermint oil, and neem oil.

13. The repellent dispenser in claim 1, comprising two dispensing horns facing opposite directions.

14. The repellent dispenser in claim 1, wherein the blower or compressor is powered by a power outlet.

15. A repellent dispenser for mosquitoes and bugs, comprising:
a body, wherein one or more repellent reservoirs and a compressor is placed in an inside of the body;
wherein, the body includes a top opening granting access to an inside of the body;
wherein, the top opening is covered by a lid;
wherein, the compressor is connected to the one or more repellent reservoirs;
wherein, a tube is connected to the compressor;
wherein, an end cap exhaust is connected to an end of the tube;
wherein, the body includes an intake hood, which draws air into the body;
wherein, the intake hood features a plurality of air inlets and a slanted surface positioned above the plurality of air inlets;
a control panel.

16. The repellent dispenser of claim 15, wherein the control panel includes a first LED light indicating whether the compressor is working.

17. The repellent dispenser of claim 15, wherein the one or more repellent reservoirs feature one or more sensors that can detect a liquid level in each of the one or more repellent reservoirs.

18. The repellent dispenser of claim 17, wherein the control panel includes one or more second LED lights respectively indicating that the liquid level drops below a threshold level in each of the one or more repellent reservoirs.

19. The repellent dispenser of claim 15, wherein the one or more repellent reservoirs include one or more types of repellent selected from the group of chemical-based repellents including DEET (N, N-Diethyl-meta-toluamide), picaridin, permethrin, IR3535, and citronella-based products; and plant-based repellents including lemon eucalyptus oil (PMD), lavender oil, tea tree oil, peppermint oil, and neem oil.

20. The repellent dispenser of claim 15, wherein the compressor can be set to operate for a preset duration, at specific intervals, at a designated time, or at a designated power level.
